(19) United States
(12) Patent Application Publication
(10) Pub. No.: US 2026/0213839 A1
(43) Pub. Date: Jul. 23, 2026

(54) Measuring Apparatus and Method for Optical Receiver

(71) Applicant: NTT, Inc., Tokyo (JP)

(72) Inventors: Toshihiro Ito, Musashino-shi, Tokyo (JP); Kentaro Honda, Musashino-shi, Tokyo (JP)

(21) Appl. No.: 19/139,729

(22) PCT Filed: Dec. 22, 2022
(86) PCT No.: PCT/JP2022/047471

§ 371 Date: Jun. 16, 2025

(51) Int. Cl. H04B 10/077; G01M 11/00; H04B 10/61

(52) U.S. Cl. CPC H04B 10/077; G01M 11/331; H04B 10/61

(57) ABSTRACT

A CMRR measurement device of the present disclosure uses a wideband light source as a test beam instead of modulated light that needs to be swept by a light component analyzer (LCA). By using a spectrum analyzer or an A/D converter as an electrical signal measuring instrument, it is possible to acquire a CMRR with a low-price general-purpose measuring instrument. It is also possible to use a combination of a wideband light source and a continuous wave (CW) light source as the test beam. An expensive measuring instrument such as an LCA is unnecessary and repetition of sweep of modulated light is not required, and it is therefore possible to acquire the CMRR in an extremely short time.

### TECHNICAL FIELD

The present invention relates to a measurement device and a measurement method of an optical receiver.

### BACKGROUND ART

Social media, video distribution, car navigation, and the like in modem society are supported by high-speed communication networks. A backbone optical communication network achieves a transmission capacity of several tens of Tbps with one optical fiber by using a wavelength multiplexing technology or a digital coherent communication technology. Unlike an intensity modulation direct detection (IMDD) technology used in short-range communication, the digital coherent communication technology achieves large-capacity transmission by including information also in a phase of light, and enables colorless reception that does not require a filter for each wavelength.

In wavelength multiplexing communication in which signals of various wavelengths are multiplexed, instead of extracting a desired channel by an optical filter or the like and decoding an optical signal by a photodiode (PD), a coherent optical receiver superimposes local oscillation light (local light) and signal light of the same frequency, and extracts a reception signal from a beat signal thereof. It is possible to extract only an optical signal of a channel that matches the wavelength of the local light without using a bulky and costly optical filter, regardless of the wavelength of the target reception light (colorless). Light of channels other than the desired channel generates noise due to detection by the PD. The noise caused by light of channels other than the desired channel is canceled in principle by an ideal balance reception operation in the coherent optical receiver and removed from an output signal obtained from a PD current.

However, when the balance between positive and complementary in the entire coherent optical receiver including an optical hybrid, the PD, and an electrical amplifier is lost, the above-described noise is not completely canceled in positive and complementary signal paths, and causes deterioration in reception characteristics. A single port rejection ratio (SPRR) serves as an indicator of whether balance in the coherent optical receiver is good or bad. The SPRR is a name based on a definition by a light input port, and is also conventionally referred to as a common mode rejection ratio (CMRR). It is necessary to correctly evaluate this SPRR (CMRR) in order to evaluate characteristics of the coherent optical receiver. In the following description, the term CMRR, which is commonly used, will be used.

The coherent optical receiver suffers a problem caused by noise that enters from only one of two optical fiber input terminals, specifically, intensity modulation noise included in signal light or relative intensity noise (RIN) included in the local light. The CMRR of the coherent optical receiver is an index indicating how much of these types of noise can be removed from a beat signal between local light and signal light, which is supposed to be detected. A CMRR is normally defined for each of four channels (XI, XQ, YI, and YQ for two polarized waves) included in the coherent optical receiver.

FIG. 10 is a diagram illustrating a definition of the CMRR in the coherent optical receiver. FIG. 10 illustrates one channel of the coherent optical receiver, which is a device under test 110 (DUT) having a signal light input terminal (sig) and a local light input terminal (LO). The coherent optical receiver includes an optical hybrid 113 and a balance PD 114 including a positive PD and a negative PD. When currents flowing through the two PDs are denoted by Ip and In, respectively, the current output from the midpoint of the balance PD can be expressed as Ip−In. It is possible to obtain the CMRR by dividing a value obtained by numerator measurement by a measurement system illustrated in the upper part of FIG. 10 by a value obtained by denominator measurement by a measurement system illustrated in the lower part of FIG. 10.

In the numerator measurement in the upper part of FIG. 10, signal light E1, which is a test beam, is input from one light input terminal, and the current output from the balance PD is expressed as Ip−In as described above. In the denominator measurement in the lower part of FIG. 10, two test beams 121 and 122 (electric fields E2 and E2e^{jΦ}) different from each other by a phase difference φ are input from two light input terminals, and the phase difference between the test beams at this time is described as φ. By changing the phase φ of the test beam 122, it is possible to acquire a maximum value output of the current of the positive PD and a maximum value output of the current of the negative PD, and thus, a PD current value corresponding to |Ip|+|In| can be obtained from the two PD current maximum values. The CMRR is defined as a ratio between these two current values (|Ip−In| and |Ip|+|Inl), and can be expressed as the following formula in dB display.

$$\begin{matrix}[ Math . 1 ] & \\ CMRR ( dB ) = 20 {log}_{10} ( \frac{\vert Δ I \vert}{\vert Ip \vert + \vert In \vert} ) , \vert Δ I \vert = \vert Ip - In \vert & Formula ( 1 )\end{matrix}$$

While the PD currents are used in the above-described definition of the CMRR, it is also possible to obtain the CMRR by connecting an amplifier such as a transimpedance amplifier (TIA) 115 indicated by a dotted line to the subsequent stage side of the balance PD and converting the current output into a voltage. In a case where the denominator and the numerator have been multiplied by the same coefficient, it is possible to obtain a current ratio by obtaining a voltage ratio. In a case where a TIA or the like is connected, a voltage output larger than a minute current from the PD can be obtained. There are various configurations of the PD and the amplifier in a case of using a voltage output as described later.

In the numerator measurement, light 120 input from one light input terminal (sig) is branched by the optical hybrid 113 and directly input to the two PDs. At this time, in a case where the balance between positive and complementary is good in the two paths from the branching by the optical hybrid 113 to the two PDs in the balance PD 114, Ip≈In holds, and the numerator of the fraction in the CMRR definition formula is almost 0. Since the definition formula CMRR becomes a value close to 0 and is extremely smaller than 1, when a CMRR value is displayed in dB display, the value becomes a large negative value.

Since the coherent optical receiver has two light input terminals, there are two types of characteristic amounts, CMRR_sig related to the signal light input terminal and CMRR_LO related to the local light input terminal. In colorless application, CMRR_sig related to a signal light input port is important, and CMRR_LO related to the local light input terminal is involved in removal of RIN generated by a local light laser. As a conventional technology for measuring the CMRR, a method described in Non Patent Literature 1 is widely known.

FIG. 11 is a diagram illustrating a CMRR measurement system using a light component analyzer according to a conventional technology. FIG. 11(a) illustrates a CMRR numerator measurement system, and FIG. 11(b) illustrates a CMRR denominator measurement system. In a denominator measurement system 500-d in FIG. 11(b), high-frequency modulated light 123 from an LCA 501 is divided into two branches by a coupler 502, and branched test beams 125 and 126 are respectively input to the signal light input terminal (sig) and the local light input terminal (LO) of the DUT 110, which is the coherent optical receiver. Each test beam is provided to the corresponding terminal through a variable optical attenuator (VOA), a variable delay line (VDL), and a polarization controller (PC) or a phase modulator (PM). The test beams 125 and 126 input to the two input terminals are set to be substantially the same in intensity level in the PD inside the coherent optical receiver.

Specifically, it is used that the loss of a general optical hybrid is substantially the same for each branch. Light (light input intensity P_{LO}) input from the local light input terminal is evenly distributed to a polarized wave X and a polarized wave Y, and the light intensity Pin_{X_LO} input to the X side is P_{LO}/2. On the other hand, since the test beam from the light component analyzer (LCA) is polarized, it is possible to adjust the state of polarization by a polarization controller (PC) 505, thereby adjusting light including only the x-polarized wave to enter the signal light input terminal at a level Pin_{x_sig}=Psig. At this time, while the light input from the signal light input terminal is concentrated only in the x-polarized wave, the light input from the local light input terminal is evenly distributed to the x-polarized wave and the y-polarized wave as described above.

Thus, when the light input intensity P_{LO} from the local light input terminal is set to be twice a light input intensity P_{sig} from the signal light input terminal, the intensities of light beams that enter the two input terminals of the x-polarized wave channel have a relationship expressed by the following formula.

$$P i {n}_{x \_ sig} = Psig = {P}_{LO} / 2 = P i {n}_{x \_ LO}$$

As described above, it is possible to achieve equalization between a case of a signal light input (Pin_{x_sig}) and a case of a local light input (Pin_{x_LO}). When the channel of the y-polarized wave is measured, the state of polarization may be adjusted by the PC 505 so that light enters only the y-polarized wave.

In the above-described denominator measurement system 500-d, the branched test beams 125 and 126 are multiplexed by the optical hybrid in the DUT 110 and interfere, and a current output is obtained from the PD. In a case where one test beam 123 is divided into two branches and input and then multiplexed again and caused to interfere in the DUT as described above, fluctuation in phase in the optical fiber of the paths in the measurement system outside the DUT causes large fluctuation in value of optical power received by each PD. Test system paths from the coupler 502 to the two input terminals in FIG. 11(b) are individually connected by optical fibers, and the phases of the optical fibers, that is, optical path lengths, fluctuate from moment to moment due to temperature fluctuation and vibration.

In the denominator measurement according to the conventional technology in FIG. 11, a signal amplitude-modulated in a range of, for example, 0 to 50 GHz is generated in the LCA, and the test beam 123 is input from the LCA 501. The above-described fluctuation in optical path length occurs from moment to moment during, for example, about 10 seconds of the time for frequency sweep of a modulation signal, and the intensity value of light received by each PD becomes extremely unstable. In order to cope with this fluctuation in power of light received by each PD, frequency sweep measurement is repeated several tens of times from the LCA, and only an optimum result is used. That is, after repeated frequency sweep, a current value when a balance PD current output is maximized in measurement of several tens of times is selected for each frequency point, and is used as a measurement result. From the results of repeated sweep operation, it is possible to select and obtain the maximum output in a case where light is concentrated only in one of the two PDs. For the two PDs, a result is obtained in which the maximum current values are pieced together at an appropriate frequency interval for each frequency point. In the measurement of the conventional technology, sufficient fluctuation may not be obtained only by natural phase fluctuation in optical fiber, and it may not be possible to reach a maximum value. Thus, in the denominator measurement system in FIG. 11(b), a phase modulator (PM) 506 is used to cause fluctuation in a range of a wide phase condition so that the maximum value is reached.

As described in FIG. 10 and the CMRR definition formula, it is necessary to acquire an Ip maximum value and an In maximum value in the denominator measurement. The PD current values obtained from the results of repetition of the sweep operation of the modulation signal described above correspond to |Ipl and |In| in Formula (1), and denominator measurement of CMRR is achieved.

In the numerator measurement illustrated in FIG. 11(a), it is possible to perform the measurement by inputting the test beam 123 obtained by amplitude-modulating carrier light to one light input terminal as it is by the modulation signal swept by the LCA 501. Depending on whether the CMRR to be measured is a local light input CMRR_LO or a signal light input CMRR_sig, a test signal is provided to the corresponding light input terminal of the DUT 110 (Sig terminal in FIG. 11(a)). In the numerator measurement, there is no branch path in the measurement system and interference does not occur in the test beams, and it is therefore possible to obtain a stable numerator measurement result by performing frequency sweep of a modulation signal only once. It is possible to obtain the CMRR in Formula (1) by dividing a result of the numerator measurement obtained by the above-described method by a result of the denominator measurement.

### CITATION LIST

### Non Patent Literature

Non Patent Literature 1: V. Painchaud et al., “Performance of balanced detection in a coherent receiver” OPTICS EXPRESS Vol. 17, No. 5/pp. 3659 (2009)

### SUMMARY OF INVENTION

### Technical Problem

However, an actual CMRR measurement method in the conventional technology has the following problems. First, an expensive measurement device such as a light component analyzer is required, and second, since it is necessary to perform a large number of times of frequency sweep at the time of denominator measurement, it takes more than several minutes to perform the measurement. Furthermore, a recently developed optical receiver in which a coherent optical receiver and a DSP are integrated does not have an electrical output terminal and cannot be connected to a light component analyzer. In the CMRR measurement method of the conventional technology, measurement itself cannot be performed.

The present invention has been made in view of such problems, and provides a measurement device and a measurement method capable of measuring a CMRR of a coherent optical receiver at high speed with a simpler measurement configuration.

### Solution to Problem

One aspect of the present invention provides a measurement device for a common mode rejection ratio (CMRR) of a coherent optical receiver having a signal light input terminal and a local light input terminal, the coherent optical receiver including an optical hybrid connected to the signal light input terminal and the local light input terminal, and a photodiode connected to an output of the optical hybrid, the measurement device comprising: a wideband light source for outputting a test beam having a coherence length and a spectral wavelength width, the coherence length being longer than an optical path length of one interferometer inside the optical hybrid, and the spectral wavelength width corresponding to twice or more a frequency band of the CMRR to be measured; and an electrical measuring instrument for an electrical signal from the coherent optical receiver, wherein for each of numerator measurement and denominator measurement of CMRR, the test beam from the wideband light source is provided to at least one of the signal light input terminal or the local light input terminal.

Another aspect of the present invention provides a measurement method for a common mode rejection ratio (CMRR) of a coherent optical receiver having a signal light input terminal and a local light input terminal, the coherent optical receiver including an optical hybrid connected to the signal light input terminal and the local light input terminal and a photodiode connected to an output of the optical hybrid, the measurement method comprising: providing a test beam from a wideband light source to at least one of the signal light input terminal or the local light input terminal to obtain a first electrical signal by an electrical measuring instrument in numerator measurement of CMRR; providing the test beam from the wideband light source to at least one of the signal light input terminal or the local light input terminal to obtain a second electrical signal by the electrical measuring instrument in denominator measurement of CMRR; calculating the CMRR based on the first electrical signal and the second electrical signal, wherein the test beam has a coherence length longer than an optical path length of one interferometer inside the optical hybrid, and has a spectral wavelength width corresponding to twice or more a frequency band of the CMRR to be measured.

### Advantageous Effects of Invention

The CMRR measurement device of the present disclosure can acquire the CMRR of the coherent optical receiver at high speed and with high accuracy just by causing a spectrum analyzer or an ADC to acquire data and perform arithmetic processing.

### BRIEF DESCRIPTION OF DRAWINGS

FIG. 1 is a diagram illustrating a configuration of a CMRR measurement device for a signal light terminal of the first embodiment.

FIG. 2 is a diagram illustrating a configuration of the CMRR measurement device for a local light terminal of the first embodiment.

FIG. 3 is a diagram illustrating an internal configuration of a coherent optical receiver and a test beam propagation state.

FIG. 4 is a diagram illustrating variations of a combination of a PD and an electrical amplifier.

FIG. 5 is a flowchart of a measurement procedure in the CMRR measurement device of the first embodiment.

FIG. 6 is a diagram illustrating a result of measuring frequency dependence of a CMRR in comparison with a conventional technology.

FIG. 7 is a diagram illustrating a configuration of a CMRR measurement device for a signal light terminal of the second embodiment.

FIG. 8 is a flowchart of a measurement procedure in the CMRR measurement device of the second embodiment.

FIG. 9 is a diagram illustrating a result of measuring the frequency dependence of the CMRR in comparison with the conventional technology.

FIG. 10 is a diagram illustrating a definition of the CMRR in the coherent optical receiver.

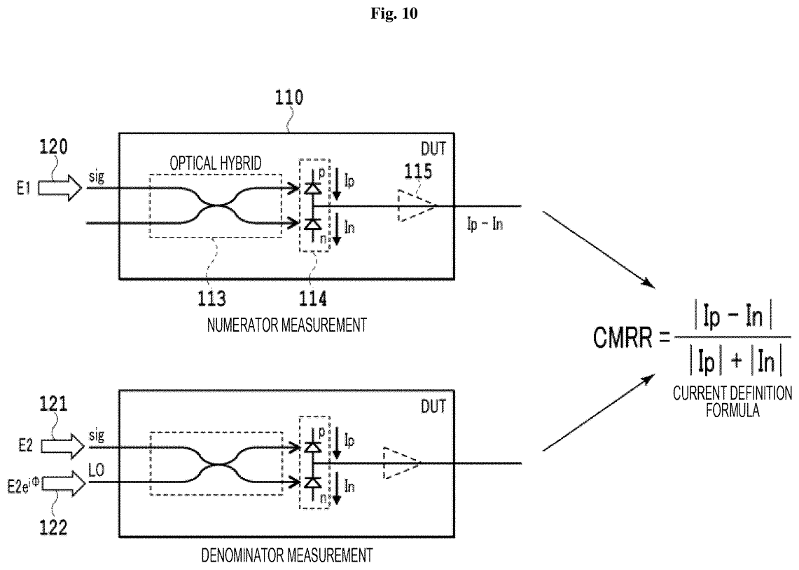

FIG. 11 is a diagram illustrating a CMRR measurement system using an LCA according to the conventional technology.

### DESCRIPTION OF EMBODIMENTS

A CMRR measurement device and a measurement method of the present disclosure use a wideband light source as a test beam. By using a spectrum analyzer or an A/D converter as an electrical signal measuring instrument, it is possible to acquire a CMRR with a lower-price general-purpose measuring instrument as compared with an LCA. A combination of a wideband light source and a continuous wave (CW) light source may be used as the test beam. That is, an expensive measuring instrument is unnecessary and repetition of sweep of modulated light is not required, and it is therefore possible to acquire the CMRR in an extremely short time.

In the CMRR measurement device and measurement method of the present disclosure, it is possible to perform numerator measurement and denominator measurement of CMRR in a short time by using the wideband light source without using a test beam intensity-modulated by a swept modulation signal.

In addition, even in a case where there is no analog electrical signal output terminal due to integration of a coherent optical receiver and a DSP, as long as the DSP has a built-in A/D converter, it is possible to use a digital value output therefrom to calculate the CMRR. A specific configuration of the CMRR measurement device of the present disclosure and a measurement procedure will be described below.

### First Embodiment

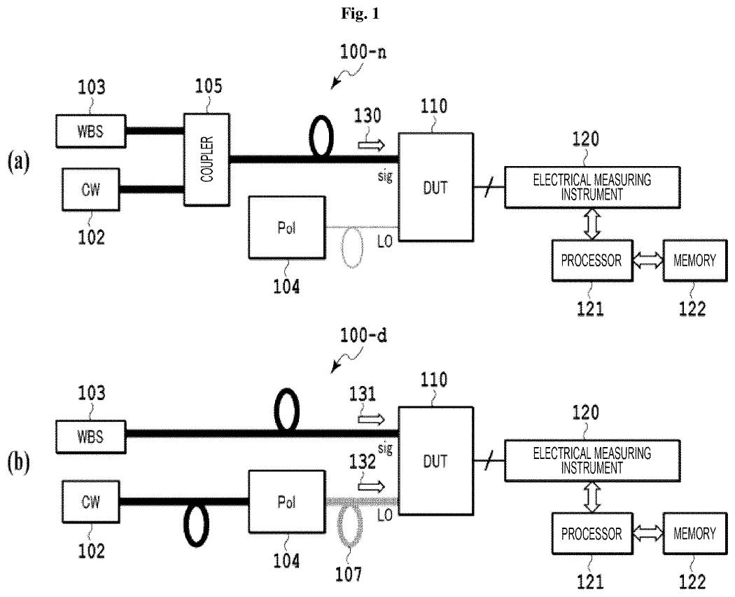

FIG. 1 is a diagram illustrating a configuration of a CMRR measurement device for a signal light input terminal (sig) of the first embodiment. FIG. 1(a) illustrates a measurement system 100-n for numerator measurement of CMRR, and FIG. 1(b) illustrates a measurement system 100-d for denominator measurement of CMRR. A DUT 110 is a coherent optical receiver, which is a CMRR measurement target, and includes two light input terminals to which optical fibers are connected and to which test beams are input, and an electrical signal output terminal connected to an electrical measuring instrument 120. Since a coherent optical receiver normally has four output channels, the DUT 110 includes electrical signal output terminals for four channels.

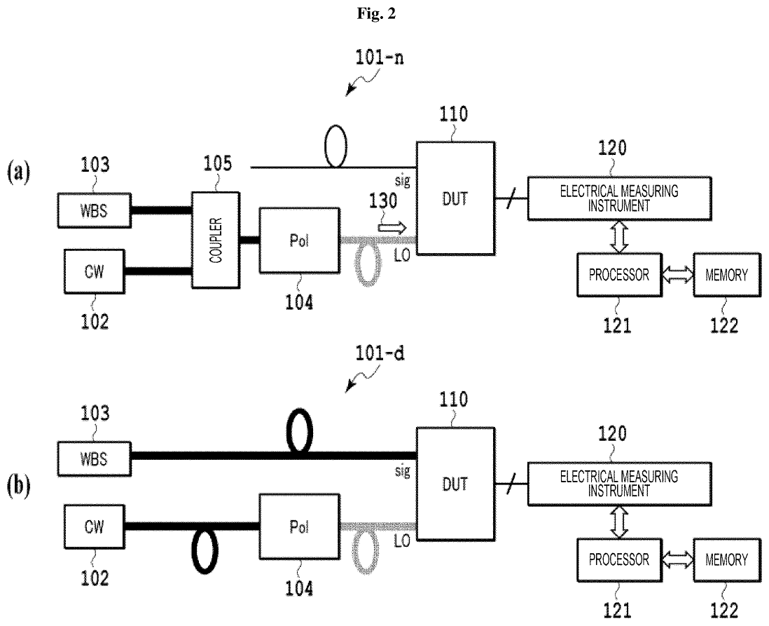

FIG. 2 is a diagram illustrating a configuration of the CMRR measurement device for a local light input terminal (LO) of the first embodiment. FIG. 2(a) illustrates a measurement system 101-n for numerator measurement of CMRR, and FIG. 2(b) illustrates a measurement system 101-d for denominator measurement of CMRR. The denominator measurement systems in FIG. 1(b) and FIG. 2(b) have the same configuration. FIGS. 1 and 2 are different only in the light input terminals (sig and LO) of a test beam 130 to the coherent optical receiver (DUT) 110 in the numerator measurement, and the following description is given on the basis of FIG. 1.

As the electrical measuring instrument 120, a spectrum analyzer is connected to the electrical signal output terminal of each output channel, and a power spectrum, which is electrical power having frequency dependence, can be acquired as an electrical signal. In addition, it is also possible to obtain a power spectrum as in the case of the spectrum analyzer by converting an electrical signal of each channel into digital data using an A/D converter and performing Fourier transform on this data.

The CMRR measurement device of the present embodiment uses two test beam light sources, a wideband light source (WBS) 103 and a continuous wave (CW) light source 102. As the wideband light source 103, it is possible to use an amplified spontaneous emission (ASE) light source, a super-continuum (SC) light source, a superluminescent diode (SLD) light source, or the like. The test beam from the wideband light source 103 may be any incoherent light in which the phase is not equalized, having a wide wavelength width corresponding to a frequency width that is twice or more the frequency band necessary for measuring the CMRR. Here, the wavelength width of the test beam from the wideband light source 103 refers to the full width at half maximum of the test beam spectrum on a wavelength axis. In the case of signal light in a 1.5 μm band, for example, a wavelength width of 1 nm corresponds to a frequency conversion bandwidth of 125 GHz, and thus allows for CMRR measurement of about 62.5 GHz or less. Since the frequency that is used for transmission and requires a CMRR is smaller than a baud rate, the wavelength width is only required to correspond to a frequency band wider than the baud rate. The wavelength of CW light is included in a wavelength bandwidth of wideband light.

As the CW light source, it is possible to use, for example, a laser light source in an integrated tunable laser assembly (ITLA) specification for communication standardized by the OIF. The test beam from the CW light source is monochromatic light, outputs highly coherent light with equalized wavelength and phase, and has a wavelength width narrower than, for example, about 10 MHz. The wavelength of the CW light source is set to fall within the range of the wavelength width of the wideband light source. For example, it may be set so as to be at the center of the wavelength width of the wideband light source.

In the numerator measurement system 100-n for CMRR_sig in FIG. 1(a), wideband light and CW light from the two light sources 102 and 103 described above are coupled by a coupler 105, and then input as the test beam 130 to the signal light input terminal of the DUT. Therefore, in the numerator measurement system 100-n, the coupled test beam 130 reaches a PD in the DUT 110 through a single optical fiber and the same path in the DUT 110. In the numerator measurement system 101-n for CMRR_LO in FIG. 2(a), wideband light and CW light are coupled by the coupler 105, and then input as the test beam 130 to the local light input terminal of the DUT via a polarizer 104. The polarizer 104 is used to input polarized waves of the test beam 130 to the local light input terminal while limiting the polarized waves to polarized waves designed in the local light input terminal of the coherent optical receiver.

In the denominator measurement system 100-d for CMRR_sig in FIG. 1(b), wideband light 131 from the wideband light source 103 is provided to the signal light input terminal. Furthermore, CW light from the CW light source 102 is polarized by the polarizer 104, and polarized CW light 132 is provided to the local light input terminal. The polarizer 104 and the local light input terminal are connected by a polarized wave maintaining fiber 107 with a polarized wave state maintained. In the case of the denominator measurement system 100-d, the wideband light 131 and the CW light 132 individually reach the PD via different paths of an optical hybrid in the DUT 110. In a case where the output of the CW light source has already been polarized and matches the polarized wave designed in the local light input terminal of the coherent optical receiver, the polarizer 104 is unnecessary.

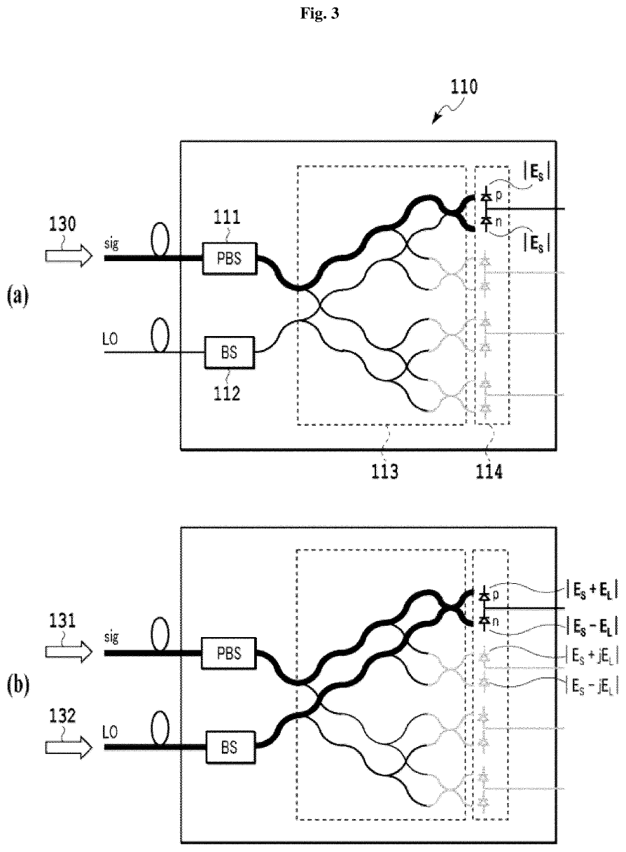

In both cases of the numerator measurement system 100-n and the denominator measurement system 100-d, different test beams from the two light sources are input to the DUT, and as will be described later, the test beams enter two PDs in a balance PD, through the same path of the optical hybrid in the case of numerator measurement, or through different paths of the optical hybrid in the case of denominator measurement. As a result, as will be further described with reference to FIG. 3, it is possible to determine the CMRR by obtaining the ratio between the output power spectra of the two measurements.

An electrical signal output from the coherent optical receiver (DUT) is input to the electrical measuring instrument 120 such as a spectrum analyzer and recorded as electrical signal data. From the ratio between the electrical signal data at the time of numerator measurement and the electrical signal data at the time of denominator measurement, the value of the CMRR can be calculated for each modulation frequency according to Formula (1).

FIG. 3 is a diagram illustrating an example of an internal configuration of the coherent optical receiver and a test beam propagation state. FIG. 3(a) illustrates a case of numerator measurement for CMRR_sig, which corresponds to the operation in the numerator measurement system 100-n in FIG. 1(a). A polarization beam splitter (PBS) 111 is disposed on a signal light input side of the coherent optical receiver 110, and a beam splitter (BS) 112 is disposed on a local light input side. An output of the PBS and an output of the BS are further input to a polarized wave multiplexing optical hybrid 113, and the outputs constitute a total of four reception channels: I and Q channels of the x-polarized wave and I and Q channels of the y-polarized wave. An interference light output of each channel of the polarized wave multiplexing optical hybrid 113 is detected by the two PDs of the corresponding balance PD 114 and converted into an electrical signal as a PD current. FIG. 3(b) illustrates a case of denominator measurement for CMRR_sig, which corresponds to the operation in the denominator measurement system 100-d in FIG. 1(b). In both of FIGS. 3(a) and 3(b), focus is placed on the balance PD of the uppermost channel among the four channels, and the path of the test beam that reaches the balance PD is illustrated in bold.

In the numerator measurement in FIG. 3(a), as an electric field Es of light that reaches the two PDs from the light source, the test beam 130 is input from one signal light input terminal. In the first embodiment, the test beam 130 is light constituted by a mixture of wideband light and CW light. When the electric field of the wideband light is E₁ and the electric field of the CW light is E2, both of the light beams reach through the same one path, and thus there is no difference in relative phase of the two light beams between a p-side PD and an n-side PD. Thus, in a case where the electric field of the light that reaches the p-side PD is |E₁+E₂|, the electric field of the light that reaches the n-side PD can also be expressed as |E₁+E₂|. The wideband light has a wide wavelength width, and when this is expressed as the sum of electric fields E₁ᵢ for each discrete wavelength i, this is expressed as the following formula.

$$\begin{matrix}[ Math . 2 ] & \\ {E}_{1} = {\sum }_{i} {E}_{1 i} & Formula ( 2 ‐ 1 )\end{matrix}$$

At this time, PD currents Ip and In caused by light incident on the corresponding PDs are proportional to the square of the incident electric field, and are expressed as the following formula when a proportionality coefficient is α.

$$\begin{matrix}[ Math . 3 ] & \\ Ip , In {=}_{.}^{.} α {\vert {E}_{1} + {E}_{2} \vert}^{2} = α {\vert {\sum }_{i} {E}_{1 i} + {E}_{2} \vert}^{2} = α ( {\vert {\sum }_{i} {E}_{1 {i}_{2}} \vert}^{2} + {\vert {E}_{2} \vert}^{2} + {\sum }_{i} ( {E}_{1 i} {E}_{2}^{*} + {E}_{1 i}^{*} {E}_{2} ) ) = α ( {\vert {E}_{1} \vert}^{2} + {\vert {E}_{2} \vert}^{2} + {\sum }_{i} ( {E}_{1 i} {E}_{2}^{*} + {E}_{1 i}^{*} {E}_{2} ) ) & Formula ( 2 ‐ 2 )\end{matrix}$$

Since the CW light is light having a single wavelength and a beat signal |E₂|² between beams of the CW light itself includes only low-frequency components of MHz or less, the beat signal |E₂|² does not normally appear in an output frequency spectrum of a PD current that measures 10 MHz or more. As will be described later, the light intensity of the wideband light is set to a level lower than that of the CW light by 10 dB or more in the measurement system in FIG. 1, and thus the value of a beat signal |E₁|² is also smaller than a beat signal between E₁ and E₂ expressed by the following Formula (3-1).

$$\begin{matrix}[ Math . 4 ] & \\ {\sum }_{i} ( {E}_{1 i} {E}_{2}^{*} + {E}_{1 i}^{*} {E}_{2} ) & Formula ( 3 ‐ 1 )\end{matrix}$$

Thus, Formula (2-2) is simplified as follows.

$$\begin{matrix}[ Math . 5 ] & \\ {I}_{p} , {I}_{n} {=}_{.}^{.} α ( {\sum }_{i} ( {E}_{1 i} {E}_{2}^{*} + {E}_{1 i}^{*} {E}_{2} ) ) & Formula ( 3 ‐ 2 )\end{matrix}$$

Here, when P₀ is defined as shown in the following formula, a relationship of Formula (3-3) is established for the PD currents Ip and In.

$$\begin{matrix}[ Math . 6 ] & \\ {P}_{0} = ( {\sum }_{i} ( {E}_{1 i} {E}_{2}^{*} + {E}_{1 i}^{*} {E}_{2} ) ) & \end{matrix}$$

$$\begin{matrix}[ Math . 7 ] & \\ {I}_{p} , {I}_{n} {=}_{.}^{.} {αP}_{0} & Formula ( 3 ‐ 3 )\end{matrix}$$

P₀ is optical power generated by a beat between beams of wideband light of the wideband light source, and represents a random optical signal having a frequency band close to the wavelength width of the wideband light. As an electrical output from the two PDs in the balance PD, a differential signal corresponding to ΔI=|Ip−In| is generated in the case of the PD currents, in accordance with the degree of device asymmetry of a p-PD and an n-PD, that is, an imbalance between positive and complementary paths. According to the CMRR definition formula described in Formula (1), it is possible to obtain the numerator in the log term by obtaining |Ip−In|. |Ip−In| is obtained from the difference between the currents of the two PDs in the balance PD by the numerator measurement in FIGS. 1(a) and 3(a). That is, from a differential output ΔI, a value corresponding to the numerator in the log term of the CMRR definition formula can be obtained as it is. It is possible to convert this current into a voltage by a 50Ω system or a TIA, and finally obtain a power spectrum An(f) corresponding to the numerator measurement.

Next, while the CMRR definition formula (1) uses the PD currents, it is also possible to obtain the CMRR by converting a current output into a voltage. In a case where the denominator and the numerator have been multiplied by the same coefficient, it is possible to obtain a current ratio by obtaining a voltage ratio. In a case where a TIA or the like is connected, a voltage output larger than a minute current from the PD can be obtained.

In the denominator measurement in FIG. 3(b), the wideband light 131 is input from the signal light input terminal, and the CW light 132 is input from the local light input terminal. The polarized wave multiplexing optical hybrid 113 is designed such that, as for relative phases of light (electric field Es) from the signal light input terminal and light (electric field E_{L}) from the local light input terminal in a wavelength band to be used, the phases of the light beams that reach the p-PD and the n-PD are shifted by 180° from each other. When the electric field of the wideband light 131 that enters from the signal light input terminal and reaches the p-PD on the p side is E₁, the electric field of the CW light 132 that enters from the local light input terminal and reaches the n-PD on the n side is E₂, and the absolute value of the electric field that enters the p-PD is |E₁+E₂|, the absolute value of the electric field incident on the n-PD can be described as |E₁−E₂|.

In CMRR measurement, in order to allow optical waves that are input and output by the optical hybrid to maintain the above-described phase relationship as designed, the test beam from the light source needs to have a coherence length longer than an optical path length of an interferometer inside the optical hybrid. When the wavelength of light from the light source is, and the wavelength width is Δλ, the coherence length is expressed by λ²/Δλ. For example, in a case where an optical path length L of the interferometer inside the optical hybrid is 0.5 mm for a wavelength of 1.55 μm, the condition for the optical path length L is Δλ<λ²/L=(1.55×10⁻⁶)²/0.5×10⁻³=5 nm. Therefore, the wavelength width of a spectral band of the wideband light needs to be narrower than 5 nm. Here, the optical path length of the interferometer inside the optical hybrid refers to an optical path length of an optical coupling and interference path configured such that a phase difference of 180 degrees is obtained when signal light and local light are coupled and incident on two PDs of one channel inside the optical hybrid.

Output currents Ip and In of the corresponding PDs at this time are proportional to the square of the electric field incident on the PD, and are expressed as the following formulas when the proportionality coefficient is α.

$$\begin{matrix}[ Math . 8 ] & \\ {{I}_{p} {=}_{.}^{.} α {\vert {E}_{1} + {E}_{2} \vert}^{2} = α \vert {\sum }_{i} {E}_{1 i} + {E}_{2} \vert}^{2} = α ( \vert {\sum }_{i} {E}_{1 i} \vert + {\vert {E}_{2} \vert}^{2} + {\sum }_{i} ( {E}_{1 i} {E}_{2}^{*} + {E}_{1 i}^{*} {E}_{2} ) ) & Formula ( 4 )\end{matrix}$$

$$\begin{matrix}[ Math . 9 ] & \\ {I}_{n} {=}_{.}^{.} α {\vert {E}_{1} - {E}_{2} \vert}^{2} = α {\vert {\sum }_{i} {E}_{1 i} - {E}_{2} \vert}^{2} = α ( \vert {\sum }_{i} {E}_{1 i} \vert + {\vert {E}_{2} \vert}^{2} - {\sum }_{i} ( {E}_{1 i} {E}_{2}^{*} + {E}_{1 i}^{*} {E}_{2} ) ) & Formula ( 5 )\end{matrix}$$

In Formula (4) and Formula (5), the first two terms are the same in sign, and thus canceling occurs and results in almost extinction in a differential current ΔI between the p-PD and the n-PD. On the other hand, since the third terms of Formula (4) and Formula (5) are opposite in sign, the terms are added in the differential current and become dominant, and an output current Iout obtained as a differential output current of the p-PD and the n-PD is expressed by the following formula.

$$\begin{matrix}[ Math . 10 ] & \\ {I}_{out} = {I}_{p} - {I}_{n} {=}_{.}^{.} 2 α {\sum }_{i} ( {E}_{1 i} {E}_{2}^{*} + {E}_{1 i}^{*} {E}_{2} ) = 2 α {P}_{0} & Formula ( 6 )\end{matrix}$$

According to the CMRR definition formula described in Formula (1), it is possible to obtain the denominator in the log term by adding |Ip| and |In|. Here, referring to Formula (3-3) of numerator measurement in the CMRR measurement device of the present embodiment, each of |Ip| and |In| substantially coincides with a value αP₀. Furthermore, referring to Formula (6), 2αP₀ is obtained by the denominator measurement in FIGS. 1(b) and 3(b), and this value corresponds to a value (|Ip|+|In|) obtained by adding |Ip| (approximately P₀) and |In| (approximately P₀). Therefore, from an output of the denominator measurement system in FIGS. 1(b) and 3(b), it is possible to obtain at once a value corresponding to the denominator in the log term of the CMRR definition formula. In addition, it is possible to convert this current into a voltage by a 50Ω system or a TIA, and finally obtain a power spectrum Ad(f) corresponding to the denominator measurement.

When An(f) obtained by the numerator measurement and Ad(f) obtained by the denominator measurement are used to obtain the CMRR corresponding to Formula (1), log is used in the case of dB display, and the power is proportional to the square of the current, and thus the following formula can be used for the calculation.

$$\begin{matrix}[ Math . 11 ] & \\ CMRR ( dB ) = 10 {log}_{10} ( \frac{{A}_{n} ( f )}{{A}_{d} ( f )} ) & \end{matrix}$$

In a case where the output of the DUT 110 is connected to a 50Ω measurement system in the measurement system in FIG. 1, 50×Iout is obtained as a voltage output. In a case where a TIA (not illustrated) is connected to the output side of each PD of the coherent optical receiver 110 in FIG. 3, Zₜ×Iout is obtained as a voltage output, where Zₜ is a transimpedance. In both the numerator measurement and the denominator measurement, the power spectrum of the voltage output can be obtained by the electrical measuring instrument 120.

As described above, the value of the power spectrum An(f) corresponding to ΔI=|Ip−In| or ΔI is obtained by the numerator measurement system 100-n in FIG. 1(a), and the value of |Ip|+|In| or the power spectrum Ad(f) corresponding thereto is obtained by the denominator measurement system 100-d in FIG. 1(b). By obtaining the ratio between these two values, it is possible to calculate the CMRR for each frequency band. However, the configuration of the paths from the two light sources 102 and 103 to the light input terminals (sig and LO) of the DUT is different between the numerator measurement system and the denominator measurement system, and the optical loss from the light source to the PD is different for each test beam. In order to obtain the correct value of the CMRR, it is necessary to equalize absolute values of electric fields of light beams that reach the PD.

Specifically, it is necessary to acquire an output power spectrum under a condition that the absolute value of the electric field of the light that reaches the PD at the time of numerator measurement is the same as the absolute value of the electric field of the light that reaches the PD at the time of denominator measurement. This may be achieved by, for example, adjusting output levels of the test beams from the light sources so that the power supply currents from the two PDs become equal to each other.

Therefore, the present invention can be implemented as a measurement device for a common mode rejection ratio (CMRR) of a coherent optical receiver having a signal light input terminal and a local light input terminal, the coherent optical receiver including an optical hybrid connected to the signal light input terminal and the local light input terminal and a photodiode connected to an output of the optical hybrid, in which the measurement device comprising: a wideband light source for outputting a test beam having a coherence length and a spectral wavelength width, the coherence length being longer than an optical path length of one interferometer inside the optical hybrid, and the spectral wavelength width corresponding to twice or more a frequency band of the CMRR to be measured; and an electrical measuring instrument for an electrical signal from the coherent optical receiver, wherein for each of numerator measurement and denominator measurement of CMRR, the test beam from the wideband light source is provided to at least one of the signal light input terminal or the local light input terminal.

Light obtained by combining the wideband light from the wideband light source and CW light from the continuous wave (CW) light source is provided to either the signal light input terminal or the local light input terminal for the numerator measurement of CMRR, and the CW light has a wavelength included in the wavelength bandwidth of the wideband light. The wideband light from the wideband light source is provided to the signal light input terminal, and the CW light from the continuous wave (CW) light source is provided to the local light input terminal for the denominator measurement of CMRR.

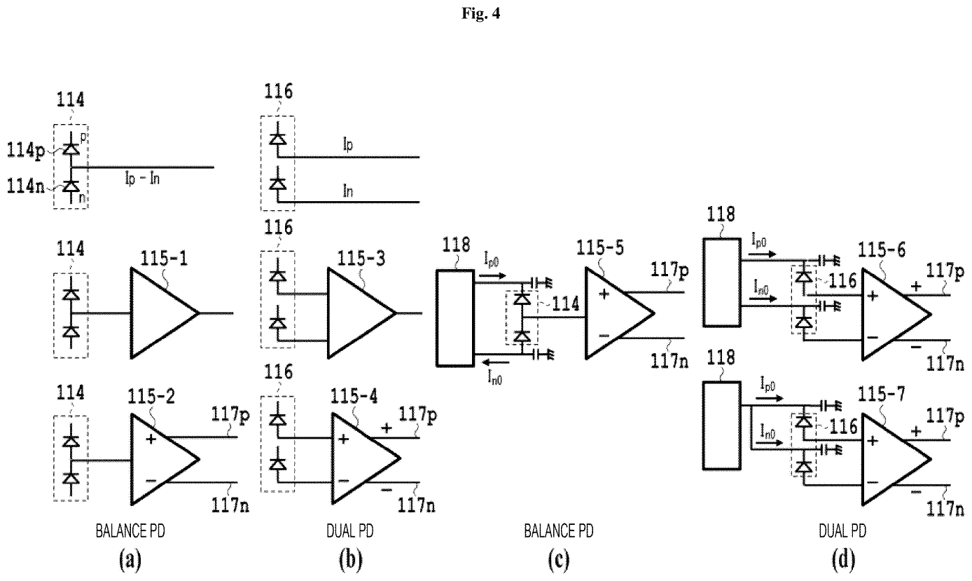

FIG. 4 is a diagram illustrating variations of a combination of a PD and a TIA. In the above description of FIGS. 1 to 3, the coherent optical receiver outputs the differential current from the balance-type PD 114 in FIG. 4(a). As a modification, the balance-type PD 114 may be connected with a single-input single-end output TIA 115-1. Alternatively, the balance-type PD 114 may be connected with a single-input differential-output TIA 115-2 having differential electrical outputs 117p and 117n.

FIG. 4(b) illustrates a case where a pair of two PDs (dual PD) 116 that are not connected in balance and are disposed in parallel is used, and an output proportional to a current difference between the two PDs can be obtained even when combined with a differential-input single-output TIA 115-3 or a differential-input differential-output TIA 115-4 having the differential electrical outputs 117p and 117n. In any of the cases where an amplifier such as a TIA is connected, a larger electrical output can be obtained. FIGS. 4(c) and 4(d) will be described later.

Next, a more specific measurement procedure in the CMRR measurement device in FIG. 1 will be described. After the DUT 110 has been set in the numerator measurement system in FIG. 1(a) or the denominator measurement system in FIG. 1(b), the wideband light source 103 and the CW light source 102 are set under the control of a processor 121 or set manually, and an electrical signal from the electrical measuring instrument 120 is acquired. The acquired electrical signal is converted into digital data by an A/D converter or the like built in the electrical measuring instrument, and is subjected to arithmetic processing by the processor 121. The processor 121 may temporarily store data in an associated memory 122 and then perform arithmetic processing. In a case where the processor is not always connected to the measuring instrument, the processor may extract data from the measuring instrument after completion of measurement.

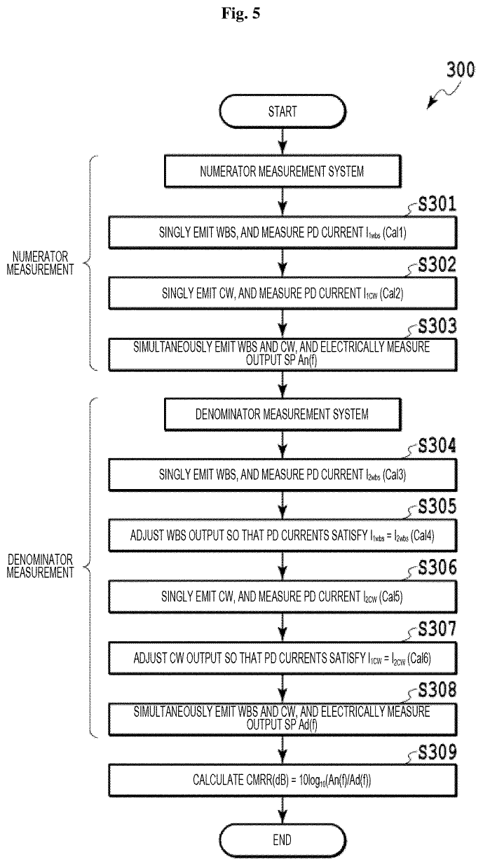

FIG. 5 is a flowchart of a measurement procedure in the CMRR measurement device of the first embodiment. This is a procedure in a case where CMRR_sig related to the signal light input terminal is measured by the measurement systems 100-n and 100-d illustrated in FIG. 1. A flow 300 includes processes of numerator measurement, denominator measurement, and CMRR calculation, and also includes processes of calibration denoted by Cal.

In S301, in the numerator measurement system in FIG. 1(a), only the wideband light is singly input from the wideband light source 103 to a sig terminal. For one channel of the DUT, a total value (Iₚ₀+Iₙ₀) of photocurrents supplied from the power supply to the PD, that is, a current value I_{1wbs}, is measured as described later together with FIGS. 4(c) and 4(d) (calibration process 1). The current value I_{1wbs} is used for calibration for the wideband light in the denominator measurement described later.

In a case of a configuration using a differential output IC among the variations of a combination of a PD and a TIA in FIG. 4, Iₚ₀ and Iₙ₀ can be measured using an ammeter-equipped power supply as a part of the electrical measuring instrument. Specifically, as illustrated in FIGS. 4(c) and 4(d), the values can be obtained by measuring currents supplied from an ammeter-equipped power supply 118 to the PD. In the case of FIG. 4(d), the value Iₚ₀+Iₙ₀ of the sum of the currents can be directly obtained by the ammeter-equipped power supply.

In S302, in the numerator measurement system in FIG. 1(a), only CW light is singly input from the CW light source 102 to the sig terminal. For one channel of the DUT, the total value (Iₚ₀+Iₙ₀) of the PD photocurrents, that is, a current value I_{1CW}, is measured (calibration process 2). The current value I_{1CW} is used for calibration for the CW light in the denominator measurement described later.

In S303, in the numerator measurement system 100-n in FIG. 1(a), test beams are input individually from the wideband light source 103 and the CW light source, and are mixed and input as the test beam 130, and the electrical measuring instrument 120 measures the output power spectrum An(f). As described above, the frequency characteristic An(f) can be directly acquired by a spectrum analyzer. It is also possible to acquire An(f) by converting electrical signals in a certain period of time into digital output data by using an A/D converter, and performing Fourier transform on the data. Control, arithmetic processing, and the like for spectrum acquisition are performed by the processor 121, and it is also possible to use the memory 122.

In S304, in the denominator measurement system 100-d in FIG. 1(b), only the wideband light from the wideband light source 103 is singly input to the sig terminal. For one channel of the DUT, the total value (Iₚ₀+Iₙ₀) of the PD photocurrents, that is, a current value I_{2wbs}, is measured (calibration process 3).

In S305, output intensity of the wideband light source 103 is adjusted so that the measured current value I_{2wbs} becomes equal to the current value I_{1wbs} acquired in S301 (I_{1wbs}=I_{2wbs}) (calibration process 4).

In S306, in the denominator measurement system 100-d in FIG. 1(b), only the CW light from the CW light source 102 is singly input to the LO terminal. For one channel of the DUT, the total value (Iₚ₀+Iₙ₀) of the PD photocurrents, that is, a current value I_{2CW}, is measured (calibration process 5).

In S307, output intensity of the CW light source 102 is adjusted so that the measured current value I_{2CW} becomes equal to the current value I_{1CW} acquired in S302 (I_{2CW}=I_{1CW}) (calibration process 6).

In S308, in the denominator measurement system 100-d in FIG. 1(b), test beams are incident individually from the wideband light source 103 and the CW light source, and an output power spectrum Ad(f) is measured by the electrical measuring instrument 120. Similarly to the output power spectrum An(f), it is possible to acquire Ad(f) by a spectrum analyzer or by using an A/D converter. Control, arithmetic processing, and the like for spectrum acquisition are performed by the processor 121, and it is also possible to use the memory 122.

In S309, a ratio is obtained by dividing the output power spectrum An(f) by the output power spectrum Ad(f) for each frequency band, and thus the value of the CMRR is calculated.

As is apparent from the above-described procedure, there is also an aspect as a CMRR measurement method including the processes (steps) S301 to S309.

In S302 described above, in the measurement of the total value (Iₚ₀+Iₙ₀) of the PD photocurrents, that is, the current value I_{1CW}, the sum of Iₚ₀ and Iₙ₀ when only the wideband light is provided to either the signal light input terminal or the local light input terminal is obtained as the first total current for the numerator measurement of CMRR. In S304 described above, in the measurement of the total value (Iₚ₀+Iₙ₀) of the PD photocurrents, that is, the current value I_{2wbs}, the sum of Iₚ₀ and Iₙ₀ when only the wideband light is provided to either the signal light input terminal or the local light input terminal is obtained as the second total current for the CMRR denominator measurement.

Therefore, for each light source used for measurement, the light intensity of the test beam from the light source in the numerator measurement and that in the denominator measurement are adjusted in such a way that the sum (Iₚ₀+Iₙ₀) of the power supply currents of the two photodiodes when the test beam is provided to either the signal light input terminal or the local light input terminal in the denominator measurement of CMRR becomes equal to the sum (Iₚ₀+Iₙ₀) of the power supply currents of the two photodiodes in the numerator measurement of CMRR.

In S305, an intensity adjustment amount at the time of adjusting the output intensity of the wideband light source 103 so that I_{1wbs}=I_{2wbs} holds can also be used as a correction value (correction coefficient) of CMRR calculation. For example, instead of equalizing the currents, it is possible to acquire first the spectrum Ad(f) and Ad(f) data with test beam intensity that allows an electrical signal from the DUT to fall within a good operation range of the electrical measuring instrument, and then correct the acquired data using the intensity adjustment amount. For example, in a case where the measurement has been performed with light intensity twice that in a case of the current supposed to be set, it is possible to halve an output result and perform correction. The processes of calibration in the flow 300 are an example of acquiring the spectrum Ad(f) after equalizing detection levels of the PDs, and the correction coefficient obtained by separately performing the calibration procedure as a whole may be applied to the acquired data later.

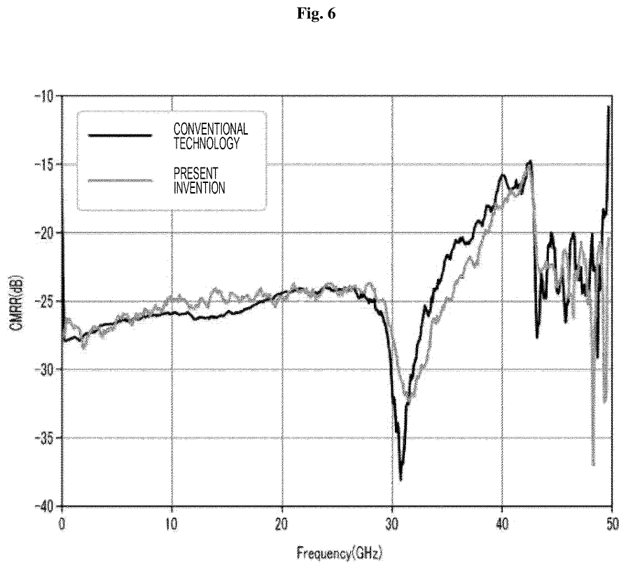

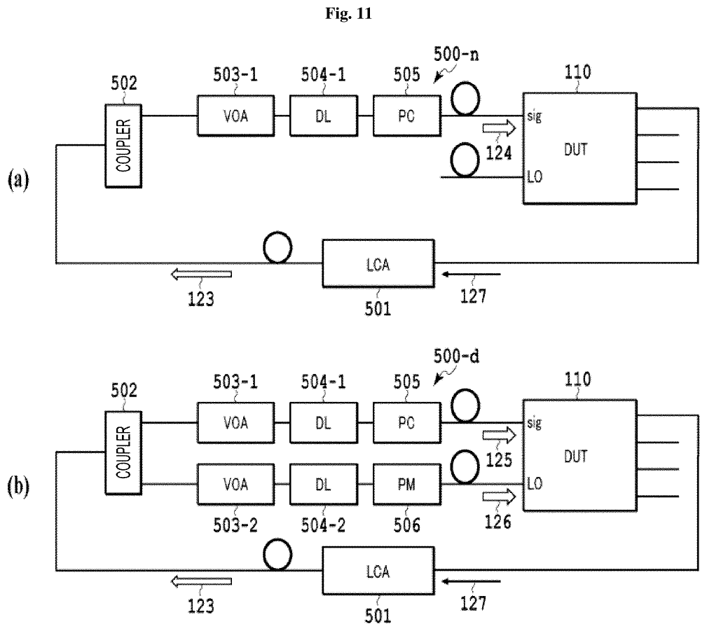

FIG. 6 is a diagram illustrating a result of measuring the frequency dependence of the CMRR in comparison with the conventional technology. CMRR_sig for the sig terminal of a frequency band of 50 GHz or less by the measurement system of the first embodiment in FIG. 1 is shown. A result of measurement by the LCA of the conventional technology illustrated in FIG. 11 is also shown for comparison between the two. It can be confirmed from the comparison with the conventional technology that the difference in measurement value is at most about several dB in any band, the frequency dependence is almost accurately reproduced, and the results coincide with each other with a certain accuracy.

In the CMRR measurement device of the present disclosure, wideband light is used as one of test beams, and this eliminates the need for a test beam in which a modulation frequency has been swept by an LCA or the like. This simplifies the CMRR measurement device and achieves short-time measurement. Also in a case of measurement of CMRR_LO for the LO terminal illustrated in FIG. 2, since only the sig terminal in the numerator measurement is replaced with the LO terminal, it is possible to apply the procedure of the measurement flow illustrated in FIG. 5 as it is only by slightly adjusting a part of the numerator measurement.

In the CMRR measurement device of the present disclosure, wideband light having a wide bandwidth is used as a test beam, and thus, a beat signal generated in the PD in the coherent optical receiver has a frequency band sufficient for measuring the CMRR, and substitutes for a test beam intensity-modulated by a modulation signal subjected to frequency sweep. In the CMRR measurement device of the present embodiment, two types of light sources including a wideband light source are used, and it is also possible to achieve equivalent CMRR measurement with a simpler configuration using only a wideband light source.

### Second Embodiment

The CMRR measurement device of the first embodiment described above uses two types of test beams, wideband light and CW light. The present embodiment provides a CMRR measurement method with a simpler configuration using only wideband light as test beams.

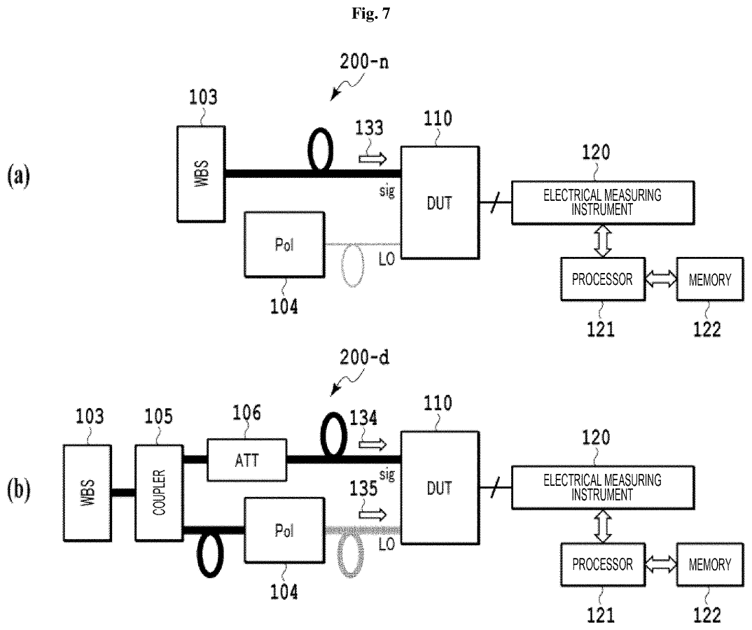

FIG. 7 is a diagram illustrating a configuration of a CMRR measurement device for a signal light terminal (sig) of the second embodiment. FIG. 7(a) illustrates a measurement system 200-n for numerator measurement of CMRR, and FIG. 7(b) illustrates a measurement system 200-d for denominator measurement of CMRR. A DUT 110 is a coherent optical receiver, which is a CMRR measurement target, and includes two light input terminals to which optical fibers are connected and to which test beams are input, and an electrical signal output terminal connected to an electrical measuring instrument 120.

In the numerator measurement system 200-n, wideband light 133 from a wideband light source 103 is provided as a test beam to a signal light input terminal of the DUT. Therefore, in the numerator measurement system 200-n, the test beam 133 reaches a PD via a single optical fiber and one path in the DUT 110.

In the denominator measurement system 200-d of CMRR in FIG. 7(b), wideband light 131 from the wideband light source 103 is branched into two paths by a coupler 105, and one is provided as a test beam 134 to the signal light input terminal and the other is provided as a test beam 135 to a local light input terminal. The test beam 134 is level-adjusted by an optical attenuator 106 and input to the signal light input terminal. The test beam 135 to the local light input terminal is polarized by a polarizer 104, and the polarizer 104 and the local light input terminal are connected by a polarized wave maintaining fiber with a polarized wave state maintained. In the case of the denominator measurement system 200-d, the two branched wideband light beams 134 and 135 individually reach the PD via different paths of an optical hybrid in the DUT 110. The polarizer 104 is unnecessary in a case where the polarized wideband light can be input with a polarized wave suitable for local light input of the optical receiver.

Similarly to the description of the measurement device of the first embodiment given with reference to the internal configuration of the coherent optical receiver in FIG. 3, description will be given that the numerator measurement and denominator measurement of CMRR can be performed by the measurement systems in FIG. 7. The internal configuration and operation of the DUT in FIG. 3 are the same with those in the CMRR measurement device of the present embodiment, except that the test beams are different from those in the case of the first embodiment.

In the numerator measurement in FIG. 7(a), the wideband light has a wide wavelength width in an electric field E₁ of the light that reaches two PDs from the wideband light source 103, and when this is expressed as a sum for each discrete wavelength i, this can be expressed as the following formula.

$$\begin{matrix}[ Math . 12 ] & \\ {E}_{1} = {\sum }_{i} {E}_{1 i} & Formula ( 7 ‐ 1 )\end{matrix}$$

At this time, PD currents Ip and In caused by light incident on the corresponding PDs have a relationship proportional to the square of the electric field E₁ of the light, and are expressed as the following formula when a proportionality coefficient is α.

$$\begin{matrix}[ Math . 13 ] & \\ {I}_{p} , {I}_{n} {=}_{.}^{.} α {\vert {E}_{1} \vert}^{2} = α {\vert {\sum }_{i} {E}_{1 i} \vert}^{2} & Formula ( 7 ‐ 2 )\end{matrix}$$

Here, when P₁ is defined as shown in the following formula, Iₚ and Iₙ are expressed as the following Formula (7-4).

$$\begin{matrix}[ Math . 14 ] & \\ {P}_{1} = {\vert {\sum }_{i} {E}_{1 i} \vert}^{2} & Formula ( 7 ‐ 3 )\end{matrix}$$

$$\begin{matrix}[ Math . 15 ] & \\ {I}_{p} , {I}_{n} {=}_{.}^{.} α {P}_{1} & Formula ( 7 ‐ 4 )\end{matrix}$$

P₁ in Formula (7-3) is optical power generated by a beat between beams of wideband light from the wideband light source, and Formula (7-3) represents that a random optical signal having a frequency band close to the wavelength width of the spectrum of the wideband light reaches the PD. That is, in a state in which the same random optical signals having optical power P₁ have been input to the two PDs, as an electrical output from the two PDs in a balance PD, a differential signal corresponding to ΔI=|Iₚ−Iₙ| is generated in the case of the PD currents, in accordance with the degree of device asymmetry of a p-PD and an n-PD, that is, an imbalance between positive and complementary paths. According to the CMRR definition formula described in Formula (1), it is possible to obtain the numerator in the log term by obtaining |Iₚ−Iₙ|. |Iₚ−Iₙ| is obtained from the difference between the currents of the two PDs in the balance PD by the numerator measurement in FIG. 7(a). That is, from a differential output ΔI, a value corresponding to the numerator in the log term of the CMRR definition formula can be obtained as it is. It is possible to convert this current into a voltage by a 50Ω system or a TIA, and finally obtain a power spectrum An(f) corresponding to the numerator measurement.

In the denominator measurement in FIG. 7(b), an electric field caused by a beat between the test beam 134 incident from the signal light input terminal and the test beam 135 incident from the local light input terminal has a phase shifted by 180 degrees between the p-PD and the n-PD as in the case of the denominator measurement system of the first embodiment in FIG. 1(b).

As described also in FIG. 3(b) illustrating the denominator measurement system of the first embodiment, the electric field of the wideband light 134 that enters from the signal light input terminal and reaches the p-PD is denoted by E₁, and the electric field of the wideband light 135 that enters from the local light input terminal and reaches the n-PD is denoted by E₂. At this time, the absolute value of the electric field that enters the p-PD can be described as |E₁+E₂|, and the absolute value of the electric field incident on the n-PD can be described as |E₁−E₂|.

In CMRR measurement, in order to allow optical waves that are input and output by the optical hybrid to maintain such a phase relationship as designed, the test beam from the light source needs to have a coherence length longer than an optical path length of an interferometer inside the optical hybrid. When the wavelength of light from the light source is λ and the wavelength width is Δλ, the coherence length is expressed by λ²/Δλ. For example, in a case where an optical path length L of the interferometer inside the optical hybrid is 0.5 mm for a wavelength of 1.55 μm, the condition for the optical path length L is Δλ<λ²/L=(1.55×10⁻⁶)²/0.5×10⁻³=5 nm. Therefore, the wavelength width of a spectral band of the wideband light needs to be narrower than 5 nm. Here, the optical path length of the interferometer inside the optical hybrid refers to an optical path length of an optical coupling and interference path configured such that a phase difference of 180 degrees is obtained when signal light and local light are coupled and incident on two PDs of one channel inside the optical hybrid.

Each of output currents of the PDs at this time is determined by the electric field incident on the PD. An electric field of a broadband signal that reaches the PD via the signal light input terminal is denoted by E₁, and an electric field of a broadband signal that reaches the PD via the local light input terminal is denoted by E₂. As in the case of the numerator, E₁ can be described as the following formula when expressed as a sum for each discrete wavelength i.

$$\begin{matrix}[ Math . 16 ] & \\ {E}_{1} = {\sum }_{i} {E}_{1 i} , {E}_{2} = {\sum }_{i} {E}_{2 i} & Formula ( 8 ‐ 1 )\end{matrix}$$

As a result, the PD currents Ip and In caused by light incident on the corresponding PDs are proportional to the square of the incident electric field, and are expressed as the following formula when the proportionality coefficient is α.

$$\begin{matrix}[ Math . 17 ] & \\ {I}_{p} {=}_{.}^{.} α {\vert {E}_{1} + {E}_{2} \vert}^{2} = α {\vert {\sum }_{i} {E}_{1 i} + {\sum }_{j} {E}_{2 j} \vert}^{2} = α {\vert {\sum }_{i} {E}_{1 i} \vert}^{2} + α {\vert {\sum }_{j} {E}_{2 j} \vert}^{2} + α ( {\sum }_{ij} ( {E}_{1 i} {E}_{2 j}^{*} + {E}_{2 j} {E}_{1 i}^{*} ) ) & Formula ( 8 a )\end{matrix}$$

$$\begin{matrix}[ Math . 18 ] & \\ {I}_{n} {=}_{.}^{.} α {\vert {E}_{1} - {E}_{2} \vert}^{2} = α {\vert {\sum }_{i} {E}_{1 i} - {\sum }_{j} {E}_{2 j} \vert}^{2} = α {\vert {\sum }_{i} {E}_{1 i} \vert}^{2} + α {\vert {\sum }_{j} {E}_{2 j} \vert}^{2} - α {\sum }_{i j} ( {E}_{1 i} {E}_{2 j}^{*} + {E}_{2 j} {E}_{1 i}^{*} ) ) & Formula ( 8 b )\end{matrix}$$

In Formula (8a) and Formula (8b), the first two terms are the same in sign, but the third term is reversed in sign, and thus, when the difference between Ip and In is calculated with the currents generated by the electric fields E₁ and E₂, the last term dominantly contributes. That is, an output current Iout obtained as a differential output current is expressed by the following formula.

$$\begin{matrix}[ Math . 19 ] & \\ {I}_{o u t} = {I}_{p} - {I}_{n} {=}_{.}^{.} 2 α ( {\sum }_{i j} ( {E}_{1 i} {E}_{2 j}^{*} + {E}_{2 j} {E}_{1 i}^{*} ) ) & Formula ( 8 c )\end{matrix}$$

E₁ and E₂ are the electric fields of the test beams that reach the PD from the same wideband light source 103 via different paths, and have the same spectrum. In a case where the intensity of the test beam from the light source and the optical attenuator are adjusted so that the two PD currents become equal to each other, it is possible to obtain |E₁|=|E₂| by equalizing the intensity when the test beam is incident from the signal light input terminal and the intensity when the test beam is incident from the local light input terminal. Specifically, in FIG. 7(b), it is possible to obtain |E₁=|E₂| by adjusting output intensity of the test beam from the wideband light source 103 and the amount of attenuation of the variable attenuator 106. At this time, Formula (8c) of the differential output current Iout can be described as the following Formula.

$$\begin{matrix}[ Math . 20 ] & \\ Iout = {I}_{p} - {I}_{n} {=}_{.}^{.} 2 α ( {\sum }_{ij} ( {E}_{1 i} {E}_{2 j}^{*} + {E}_{2 j} {E}_{1 i}^{*} ) ) & Formula ( 9 ‐ 1 )\end{matrix}$$

Here, when P₂ is defined for the right side of Formula (9-1) as shown in the following Formula (9-2), the relationship of Formula (9-3) is obtained.

$$\begin{matrix}[ Math . 21 ] & \\ {P}_{2} = ( {\sum }_{ij} ( {E}_{1 i} {E}_{2 j}^{*} + {E}_{2 j} {E}_{1 i}^{*} ) ) & Formula ( 9 ‐ 2 )\end{matrix}$$

$$\begin{matrix}[ Math . 22 ] & \\ Iout = 2 α {P}_{2} & Formula ( 9 ‐ 3 )\end{matrix}$$

P₂ represents optical signal power constituted by a beat between the test beams 134 and 135 that have been branched into two from the wideband light source 103. Therefore, as in the case of P₁ in the numerator measurement, an optical signal has been generated by a beat between beams of wideband light from the wideband light source, and thus a random optical signal having a frequency band close to the wavelength width of the wideband light is input.

According to the CMRR definition formula described in Formula (1), it is possible to obtain the denominator in the log term by adding |Ip| and |In|. P₂ in Formula (9-3) described above is an electrical signal generated by a beat between the test beams from the wideband light source. In processes of calibration to be described later, the light intensity input from the signal light input terminal to the PD and the light intensity input from the local light input terminal to the PD are set to be equal to the light intensity input from the signal light input terminal at the time of numerator measurement. Thus, even in a case where the test beams 134 and 135 are optical signals having the optical powers P₁ and P₂ and having the same spectrum, the light intensity detected by each of the two PDs increases by the amount of the test beams input from the two input terminals. This coefficient is expressed as a. The coefficient a can be obtained from theoretical calculation and actual measurement. For example, this value is 2^{1/2} in an ideal example, and it is possible to use a different value obtained by calculation with adjustment based on a condition such as a spectrum shape. Taking into consideration also adjustability of the coefficient a, Formula (9-3) can be described as follows.

$$\begin{matrix}[ Math . 23 ] & \\ Iout = {I}_{p} - {I}_{n} {=}_{.}^{.} 2 α {P}_{2} = a \times 2 α {P}_{1} & Formula ( 9 ‐ 4 )\end{matrix}$$

With reference to Formula (9-4), a value a×2αP₁ obtained by the denominator measurement system in FIG. 7(b) finally corresponds to a times the value obtained by adding |Ip| (approximately P₁) and |In| (approximately P₁). Therefore, from an output of the denominator measurement system in FIG. 7(b), it is possible to obtain at once a value corresponding to a times of the denominator in the log term of the CMRR definition formula. The CMRR can be calculated by adding correction of the coefficient a described above to an output of the denominator measurement system. It is possible to convert the current of the PD into a voltage by a 50Ω system or a TIA, and finally obtain a power spectrum Ad(f) corresponding to the denominator measurement.

As described above, the value of ΔI=|Ip−In| is obtained by the numerator measurement system 200-n in FIG. 7(a), and a value corresponding to |Ip|+|In| is obtained by the denominator measurement system 200-d in FIG. 7(b). It is possible to convert the currents at the time of numerator measurement and denominator measurement into voltages by a 50Ω system or a TIA, and finally obtain the power spectra An(f) and Ad(f) corresponding to the numerator measurement and the denominator measurement, respectively. When these values are used, the CMRR can be described as the following formula.

$$\begin{matrix}[ Math . 24 ] & \\ CMRR ( dB ) = 10 {log}_{10} ( \frac{{a}^{2} {A}_{n} ( f )}{{A}_{d} ( f )} ) & \end{matrix}$$

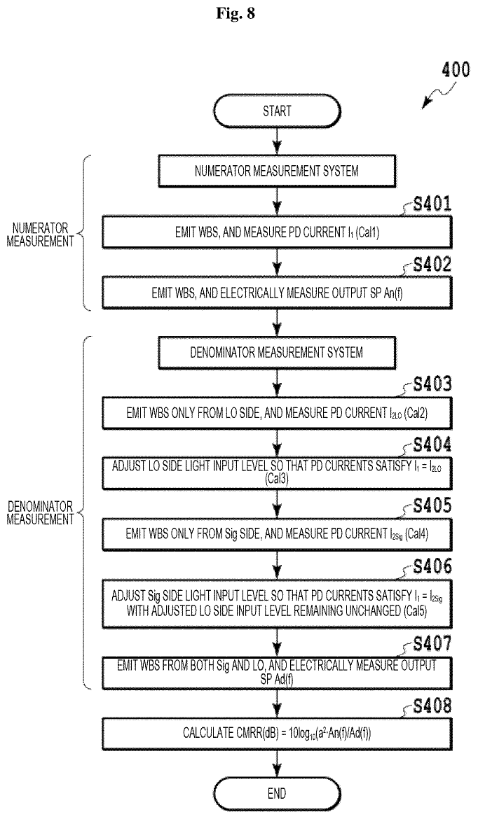

FIG. 8 is a flowchart of a measurement procedure in the CMRR measurement device of the second embodiment. This is a procedure in a case where CMRR_sig related to the signal light input terminal is measured by the measurement systems 200-n and 200-d illustrated in FIG. 7. A flow 400 includes processes of numerator measurement, denominator measurement, and CMRR calculation, and also includes processes of calibration denoted by Cal.

In S401, in the numerator measurement system in FIG. 7(a), wideband light is provided from the wideband light source 103 to the signal light input terminal. For a measurement target channel of the DUT, a total value (Iₚ₀+Iₙ₀) of photocurrents supplied from an ammeter-equipped power supply to the PD, that is, a current value I₁, is measured as in the case of the first embodiment (calibration process 1). The current value I₁ is used for calibration for the wideband light in the denominator measurement described later.

In S402, in the numerator measurement system 200-n in FIG. 7(a), the test beam 133 is incident on the signal light input terminal from the wideband light source 103, and the output power spectrum An(f) is measured by the electrical measuring instrument 120. As described above, An(f) can be acquired by a spectrum analyzer. It is also possible to acquire An(f) by converting electrical signals in a certain period of time into digital output data by using an A/D converter, and performing Fourier transform on the data. Control, arithmetic processing, and the like for spectrum acquisition are performed by a processor 121, and it is also possible to use a memory 122.

In S403, in the denominator measurement system 200-d in FIG. 7(b), the input to the signal light input terminal to the DUT 110 is removed, and the wideband light from the wideband light source 103 is provided only to the local light input terminal. The total value (Iₚ₀+Iₙ₀) of the PD photocurrents, that is, a current value I_{2LO}, is measured for the measurement target channel of the DUT (calibration process 2).

In S404, the output intensity of the wideband light source 103 is adjusted so that the measured current value I_{2LO} becomes equal to the current value I₁ acquired in S401 (I₁=I_{2LO}) (calibration process 3).

In S405, in the denominator measurement system 200-d in FIG. 7(b), the input to the local light input terminal to the DUT 110 is removed, and the wideband light from the wideband light source 103 is provided only to the signal light input terminal. The total value (Iₚ₀+Iₙ₀) of the PD photocurrents, that is, a current value I_{2Sig}, is measured for the measurement target channel of the DUT (calibration process 4).

In S406, the intensity of the test beam 134 to the signal light input terminal is adjusted with a state maintained in which the intensity of the test beam 135 to the local light input terminal that has already been adjusted remains unchanged, so that the measured current value I_{2Sig} becomes equal to the current value I₁ acquired in S401 (I_{2Sig}=I₁). That is, in the configuration in FIG. 7(b), the intensity of the test beam 134 is adjusted by the variable attenuator 106 with the intensity of the test beam 135 at the end of S404 maintained (calibration process 5). After completion of this intensity adjustment, the power of light received by the PD is equalized between the numerator measurement system and the denominator measurement system for the wideband light, and the accuracy of the CMRR measurement value is maintained.

In S407, the denominator measurement system 200-d in FIG. 7(b) causes the test beams 134 and 135 to be incident on the two input terminals, respectively, from the wideband light source 103, and the electrical measuring instrument 120 measures an output power spectrum Ad(f). As in the case of the output power spectrum An(f), Ad(f) can be acquired by a spectrum analyzer or by using an A/D converter. Control, arithmetic processing, and the like for spectrum acquisition are performed by the processor 121, and it is also possible to use the memory 122.

In S408, a ratio is obtained by dividing the output power spectrum Ad(f) by the output power spectrum Ad(f) corrected with a correction coefficient a for each frequency, and thus the CMRR is calculated. The correction coefficient a used for the calculation of the CMRR is obtained by theoretical calculation or computer simulation using the spectrum of the test beam from the test beam light source and a device model. It is also possible to perform the calculation from a measurement result of an element having a known CMRR value.

Therefore, the present invention can be implemented as a measurement method for a common mode rejection ratio (CMRR) of a coherent optical receiver having a signal light input terminal and a local light input terminal, the coherent optical receiver including an optical hybrid connected to the signal light input terminal and the local light input terminal and a photodiode connected to an output of the optical hybrid, the measurement method including: providing a test beam from a wideband light source to at least one of the signal light input terminal or the local light input terminal to obtain a first electrical signal by an electrical measuring instrument in numerator measurement of CMRR (S402); providing the test beam from the wideband light source to at least one of the signal light input terminal or the local light input terminal to obtain a second electrical signal by the electrical measuring instrument in denominator measurement of CMRR (S407); and calculating the CMRR based on the first electrical signal and the second electrical signal (S408), wherein the test beam has a coherence length longer than an optical path length of one interferometer inside the optical hybrid, and has a spectral wavelength width corresponding to twice or more a frequency band of the CMRR to be measured.

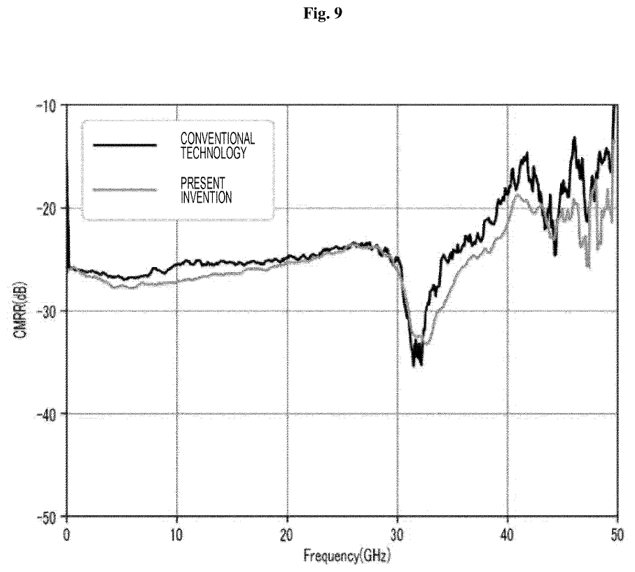

FIG. 9 is a diagram illustrating a result of measuring the frequency dependence of the CMRR in comparison with the conventional technology. CMRR_sig for the sig terminal of a frequency band of 50 GHz or less by the measurement system of the second embodiment in FIG. 7 is shown. A result of measurement by the LCA of the conventional technology illustrated in FIG. 11 is also shown for comparison between the two. It can be confirmed from the comparison with the conventional technology that the difference in measurement value is at most about several dB in any band, the frequency dependence is almost accurately reproduced, and the results coincide with each other with a certain accuracy.

Also in the CMRR measurement device of the second embodiment, the numerator measurement and the denominator measurement end with short-time measurement by the electrical measuring instrument. Only wideband light is used as a test beam, and this eliminates the need for a test beam in which a modulation frequency has been swept by an LCA or the like. Iₙ this manner, the CMRR measurement device is simplified to achieve short-time measurement. It is possible to measure CMRR_LO by replacing, with an LO terminal, the sig terminal in the numerator measurement in the measurement of CMRR_sig for the sig terminal illustrated in FIG. 7.

Various modifications and changes described below can be made to any of the above-described embodiments. The electrical measuring instrument may be any device that can analyze frequency characteristics of input electrical signals. For example, a real-time oscilloscope, a device with a built-in A/D converter such as a signal analyzer, a case where an A/D converter is built in a receiver itself, or a spectrum analyzer that directly analyzes frequency characteristics may be used. For calculation of the CMRR by a DSP, the CMRR in logarithmic display can be obtained by accumulating data of a certain period of time, performing Fourier transform, and taking the logarithm of a ratio between an absolute value of a numerator measurement value and an absolute value of a denominator measurement value.

Variations of a combination of a PD and a TIA have been described together with FIG. 4 in the first embodiment, and similar variations are also possible in the second embodiment.

The switching between paths of the numerator measurement and paths of the denominator measurement and the removal of the optical fiber in the calibration processes (Cal) can be performed by an optical switch. The test beam from the light source is not essential in a case where the test beam from the light source satisfies the condition of the wavelength width, and it is possible to set the wavelength width to the wavelength width of the light source that is finally required by, for example, appropriately limiting the band by an optical filter.

In the embodiment in FIGS. 1 and 2, the CW light source is polarized, and the ratio of light that enters the X-polarized wave side and light that enters the Y-polarized wave side through a polarization beam splitter inside the optical receiver when entering the coherent optical receiver depends on the state of polarization. In order to perform the measurement while keeping this ratio constant, a polarization controller may be used between the light source and the DUT.

In each of the above-described embodiments, the intensity of the test beam is adjusted in the calibration processes in order to equalize the reception intensity of the PD between the numerator measurement and the denominator measurement. In order to adjust the intensity of the test beam, an optical amplifier or a variable optical attenuator may be provided in at least one of the path from the light source to the signal light input terminal or the path to the local light input terminal in each of the measurement systems in FIGS. 1, 2, and 7. As described in the measurement procedures in FIGS. 5 and 8, it is possible to acquire the power spectra An(f) and Ad(f) after performing the calibration processes in both the denominator measurement system and the numerator measurement system to adjust the light intensity of the light source.

Furthermore, in the description of each of the above-described embodiments, the photocurrent supplied from the ammeter-equipped power supply 118 is measured for each output channel of the coherent optical receiver and used for calibration. In a case where it is considered that the current is substantially equivalent in each output channel, the currents from the power supply with a plurality of channels are collectively measured and divided by the number of channels, so that the current of each channel can be obtained and used for calibration.

Instead of equalizing the light intensities at the time of denominator measurement and at the time of numerator measurement, it is possible to acquire a power spectrum with a different test beam intensity for each of the numerator measurement and the denominator measurement so that an appropriate electrical signal can be acquired in consideration of the range of the output current of the PD, detection sensitivity and detection accuracy of the electrical measuring instrument, and the like, and then correct the acquired measurement data. In a case of measurement using one type of light source and test beam as in the second embodiment, when data has been acquired with the light intensity increased A-fold, correction may be performed with the output intensity of the electrical signal increased 1/A-fold. In a case of measurement using two types of light source and test beam as in the first embodiment and using a beat output of two types of test beam, when the light intensity of one test beam has been increased A-fold, correction may be performed with the output amplitude of the acquired electrical signal increased 1/√A(1/A^{1/2})-fold.

For example, in a case of numerator measurement, as is apparent from Formula (1), the better the characteristics of the CMRR, the more the currents of the p-PD and the n-PD cancel each other out, and the output power obtained from a difference current ΔI becomes extremely small. In such a situation, it is also possible to use different test beam intensities for the numerator and the denominator, such as using a stronger test beam in the numerator measurement than in the denominator measurement. As a result, the electrical signal output from the DUT can be measured so as to fall within an optimum input range of the electrical measuring instrument 120. Since the light intensity has been adjusted (A-fold), it is possible to measure the CMRR under optimum conditions of the electrical measuring instrument 120 by performing correction calculation (1/A-fold or 1/A^{1/2}-fold) on the measured electrical signal as described above.

In a case where this method is applied, a power spectrum is acquired in a state in which an electrical signal is in an optimum input range of the electrical measuring instrument, and then the measurement value is corrected. Specifically, in the light intensity adjustment in S305 and S307 in the flowchart 300 in FIG. 5, the light intensity is adjusted so that the electrical signal output amplitude falls within an optimum input range of the electrical measuring instrument 120. Thereafter, in the CMRR calculation formula in S309, it is possible to use the photocurrents obtained in S301, S302, S305, and S308 to correct the calculated value of the CMRR.

In the CMRR measurement device of any of the embodiments, it is also possible to use a method similar to that described in Non Patent Literature 1 as a simpler calibration method. More specifically, a case is considered in which the loss for each channel inside the coherent optical receiver is the same in the signal light input path and in the local light input path. For example, in the first embodiment, in a case where the signal light is light that has been polarized by causing the light to pass through a polarizer or the like, when a polarization controller is adjusted so that the signal light is concentrated only in the x-polarized wave, the input intensity of the local light may be input so as to be twice the input intensity of the signal light. At this time, unlike signal light incident only on the X side, the local light is evenly distributed to the x-polarized wave and the y-polarized wave, and in the x-polarized wave, the signal light and the local light are incident with the same intensity. According to this method, it is possible to equalize the intensities of beams of light that reach the PDs of the measurement channels can be equalized just by measuring the light intensities of the test beams input to the two terminals.

In the above-described numerator measurement system and denominator measurement system, it is possible to use an optical band pass filter to limit the band of the wideband light from the wideband light source 103 and reduce noise caused by unnecessary light. As an alternative to the wideband light source, it is also possible to use light subjected to random high-speed modulation at a speed equal to or higher than a CMRR measurement band.

In a case where the amount of memory for arithmetic processing is insufficient when measuring a time signal using an A/D converter as the electrical measuring instrument, it is possible to reduce measurement errors by performing an averaging procedure for a plurality of times of measurement. For example, it is possible to perform Fourier transform on the acquired time signal, and then obtain an average value of absolute values of different times of measurement.

Even in a case where there is no output terminal for analog electrical signals of the optical receiver due to integration of a coherent optical receiver and a DSP, output signals of the coherent optical receiver can be acquired by the DSP. Instead of using the electrical measuring instrument in FIGS. 1, 2, and 7, it is possible to acquire an electrical signal, which has been acquired by the DSP, from the output of the A/D converter normally included in the DSP for the coherent optical receiver.

During CMRR measurement, the acquired electrical signal contains thermal noise or the like of an electrical amplifier (TIA) included in the DUT. It is also possible to improve the accuracy by acquiring in advance output data of the electrical signal from the DUT at the time of no light input and subtracting a noise intensity spectrum thereof from An(f) and Ad(f).

In the measurement device of the first embodiment, a beat signal between two test beams, wideband light and CW light, is used as an input to the PD, and, as studied in Formula (3), a component of a beat signal |E₁|² between beams of wideband light is small but causes a measurement error. In the denominator measurement and the numerator measurement, it is possible to improve the accuracy by measuring output powers Bn(f) and Bd(f), respectively, in a case where only wideband light is input, and using Bn(f) and Bd(f) for correction in the following formula to obtain the CMRR.

$$\begin{matrix}[ Math . 25 ] & \\ CMRR ( dB ) = 10 {log}_{10} ( \frac{A n ( f ) - Bn ( f )}{Ad ( f ) - Bd ( f )} ) & Formula ( 10 )\end{matrix}$$

In the measurement device of the second embodiment, in the denominator measurement, inputs mainly received by the PD are beat components of test beams from the signal light input terminal and test beams from the local light input terminal, and the beat signal |E₁|² between the test beams from the signal light input terminal and a beat signal |E₂|² between the test beams from the local light input terminal also cause measurement errors. It is also possible to improve the accuracy by measuring output powers Bds(f) and Bdl(f) in a case where the test beams are input only from the signal light input terminal and in a case where the test beams are input only from the local light input terminal, and using Bds(f) and Bdl(f) for correction in the following formula to obtain the CMRR.

$$\begin{matrix}[ Math . 26 ] & \\ CMRR ( dB ) = 10 {log}_{10} ( \frac{An ( f )}{A d ( f ) / {a}^{2} - Bds ( f ) - Bdl ( f )} ) & Formula ( 11 )\end{matrix}$$

The present invention can also be used to measure another quantity in which a CMRR is included in a formula. As described above in detail, according to the CMRR measurement device of the present invention, the CMRR of the coherent optical receiver can be measured at high speed with a less expensive configuration.

### INDUSTRIAL APPLICABILITY

The present invention can be used for manufacturing an optical receiver.

1. A measurement device for a common mode rejection ratio (CMRR) of a coherent optical receiver having a signal light input terminal and a local light input terminal, the coherent optical receiver including an optical hybrid connected to the signal light input terminal and the local light input terminal and a photodiode connected to an output of the optical hybrid, the measurement device comprising:
a wideband light source for outputting a test beam having a coherence length and a spectral wavelength width, the coherence length being longer than an optical path length of one interferometer inside the optical hybrid, and the spectral wavelength width corresponding to twice or more a frequency band of the CMRR to be measured; and
an electrical measuring instrument for an electrical signal from the coherent optical receiver,
wherein for each of numerator measurement and denominator measurement of CMRR, the test beam from the wideband light source is provided to at least one of the signal light input terminal or the local light input terminal.

2. The measurement device according to claim 1, wherein the test beam from the wideband light source is provided to only one of the signal light input terminal or the local light input terminal for the numerator measurement of CMRR.

3. The measurement device according to claim 1, wherein the test beam is provided from the wideband light source to both the signal light input terminal and the local light input terminal for the denominator measurement of CMRR.

4. The measurement device according to claim 1, wherein combined light of the test beam from the wideband light source and CW light from a continuous wave (CW) light source is provided to either the signal light input terminal or the local light input terminal for the numerator measurement of CMRR, and the CW light has a wavelength included in a wavelength bandwidth of the test beam.

5. The measurement device according to claim 1, wherein the test beam from the wideband light source is provided to the signal light input terminal, and CW light from a continuous wave (CW) light source is provided to the local light input terminal for the denominator measurement of CMRR.

6. The measurement device according to claim 1, wherein
light intensity of the test beam from the wideband light source in the numerator measurement and that in the denominator measurement are adjusted such that a sum of power supply currents of two photodiodes when the test beam is provided to either the signal light input terminal or the local light input terminal in the denominator measurement of CMRR becomes equal to a sum of power supply currents of the two photodiodes in the numerator measurement of CMRR, or
a value of each of the sums of the power supply currents is used to correct a result of the numerator measurement and a result of the denominator measurement to calculate the CMRR.

7. The measurement device according to claim 1, wherein the wideband light source is any one of an amplified spontaneous emission (ASE) light source, a super-continuum (SC) light source, or a superluminescent diode (SLD) light source.

8. A measurement method for a common mode rejection ratio (CMRR) of a coherent optical receiver having a signal light input terminal and a local light input terminal, the coherent optical receiver including an optical hybrid connected to the signal light input terminal and the local light input terminal and a photodiode connected to an output of the optical hybrid, the measurement method comprising:
providing a test beam from a wideband light source to at least one of the signal light input terminal or the local light input terminal to obtain a first electrical signal by an electrical measuring instrument in numerator measurement of CMRR;
providing the test beam from the wideband light source to at least one of the signal light input terminal or the local light input terminal to obtain a second electrical signal by the electrical measuring instrument in denominator measurement of CMRR; and
calculating the CMRR based on the first electrical signal and the second electrical signal,
wherein the test beam has a coherence length longer than an optical path length of one interferometer inside the optical hybrid and has a spectral wavelength width corresponding to twice or more a frequency band of the CMRR to be measured.
